(19) United States
(12) Patent Application Publication
(10) Pub. No.: US 2017/0372057 A1
(43) Pub. Date: Dec. 28, 2017

(54) METHOD AND APPARATUS PROVIDING SECURITY USING GRAPHIC ELEMENTS

(71) Applicant: THOMSON LICENSING, Issy les Moulineaux (FR)

(72) Inventor: Matthew Joseph COBURN, Redondo Beach, CA (US)

(21) Appl. No.: 15/540,311

(22) PCT Filed: Dec. 16, 2015
(86) PCT No.: PCT/US2015/066171

§ 371 Date: Jun. 28, 2017

Related U.S. Application Data
(60) Provisional application No. 62/098,191, filed on Dec. 30, 2014.

(51) Int. Cl. G06F 21/36; H04L 29/06; G06F 17/30

(52) U.S. Cl. CPC G06F 21/36; G06F 17/30047; H04L 63/08

(57) ABSTRACT

A determination is made if user selected graphic elements, from a set of graphic elements, matches designated security criteria. Data is received where such data represents the selection of graphic elements by a user from a set of graphic elements. A determination is made by a security system if the selected graphic elements have at least one at least one physical characteristic and at least one spatial characteristic that match a security criteria. When the selected graphic elements match the security criteria defined by a profile, the user is granted access to a secured system.

### TECHNICAL FIELD OF THE INVENTION

Embodiments described herein relate generally to security and, more particularly, the use of graphical elements to authorize access to secured systems.

### BACKGROUND OF THE INVENTION

In many secured systems, a user has to enter in a password composed of different text in order to gain access to applications and hardware available through the secured system. Recently, hackers have been very successful using dictionaries containing different combinations of letters and numbers and brute force techniques to derive passwords to illicitly gain access to secured systems. In order to secure systems more efficiently and prevent brute force attacks, there is a need to use to utilize passwords that do not use combinations of text where such novel passwords need to change on a frequent basis.

### SUMMARY

This summary is provided to introduce a selection of concepts in a simplified form that are further described below in the Description of the Embodiments. This summary is not intended to identify key features or essential features of the claimed subject matter, nor is it intended to be used as an aid in determining the scope of the claimed subject matter.

Exemplary embodiments described herein can relate to, include, or take the form of a method and apparatus for generating passwords composed of graphic elements. A number of graphic elements can be selected from a database of graphic elements where the graphic elements that are selected share at least one physical characteristics. The selected graphic elements can be arranged with other graphic elements which do not share the designated physical characteristic, where combination of selected and other graphic elements form a set of graphic elements. The selected graphic elements are placed within positons in the set of graphic elements in accordance with at least one spatial characteristic. Both the physical and spatial characteristics, defined by security criteria, can change from time period to time period. The set of graphic elements can then be displayed so that a user can choose different graphic elements in the form of a visual password.

Further exemplary embodiments described herein can relate to, include, or take the form of a method and apparatus to determine if user selected graphic elements, from a set of graphic elements, match designated security criteria. Data is received where such data represents the selection of graphic elements by a user from a set of graphic elements. A determination is made by a security system if the selected graphic elements have at least one at least one physical characteristic and at least one spatial characteristic that match a security criteria. When the selected graphic elements match the security criteria defined by a profile, a user is granted access to a secured system.

Additional exemplary embodiments described herein can relate to, include, or take the form of a computing device. The computing device, and more specifically, the memory of the computing device can store instructions which, when executed by a processor of the computing device, can perform one or more of the methods described herein. Related embodiments described herein described herein can take the form of a non-transitory computer-readable storage medium. More particularly, the computer-readable storage medium includes computer executable instructions which, when executed by at least one processor, can perform one or more of the methods described herein.

### BRIEF DESCRIPTION OF THE FIGURES

Reference will now be made to representative embodiments illustrated in the accompanying figures. It is understood that the following descriptions are not intended to limit the disclosure a particular embodiment or a set of particular embodiments. To the contrary, this disclosure is intended to cover alternatives, modifications, and equivalents as can be appreciated from the described embodiments as defined by the appended claims and as illustrated in the accompanying figures:

FIG. 1 depicts a block diagram of an exemplary security server configured to generate graphical elements and provide access to a secured system;

FIG. 2 depicts a flow chart illustrating operations of an exemplary method to grant access to a system in response to correctly selected graphical elements that have attributes that match security criteria;

FIG. 3 depicts a flow chart illustrating operations of an exemplary method to generate a set of graphical elements for display containing graphical elements that match security criteria; and

FIG. 4 depicts an exemplary set of graphic elements to be selected.

The use of the same or similar reference numerals in different drawings indicates similar, related, or identical items.

### DESCRIPTION OF THE EMBODIMENTS

It should be understood that the elements shown in the Figures can be implemented in various forms of hardware, software or combinations thereof. Preferably, these elements are implemented in a combination of hardware and software on one or more appropriately programmed general-purpose devices, which can include a processor, a memory and an input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate instructions. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

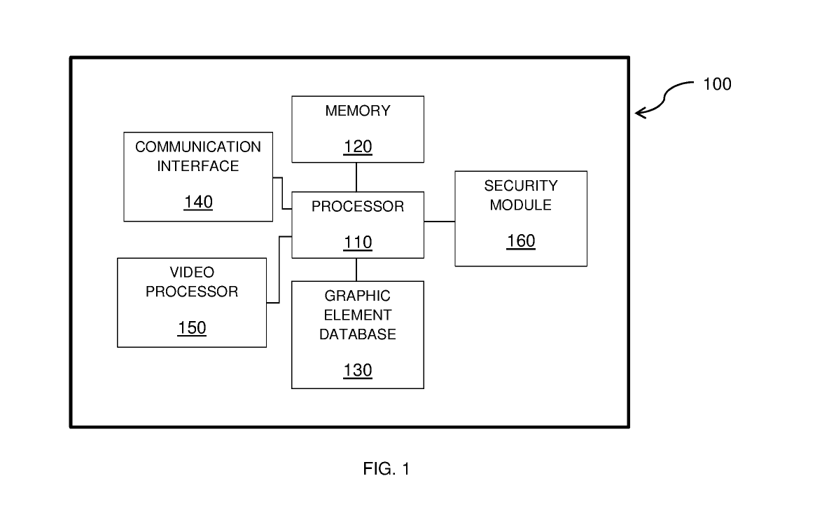

FIG. 1 depicts an exemplary security server 100 configured to generate graphical elements and provide access to a secured system The server 100, includes one or more processors 110, memory 120, graphical element database 130, communication interface 140, video processor 150, and security module 160. Each of these elements will be discussed in more detail below.

The processor 110 controls the operation of the server 100. The processor 110 runs the software that operates the server as well as provides the functionality of the software required to select and generate a set of graphic elements, and authorize access to software and hardware if the selection of graphical elements by a user is correct. The processor 110 is connected to memory 120, graphical element database 130, and communication interface 140, video processor 150, and security module 160 and handles the transfer and processing of information between these elements. The processor 110 can be general processor or a processor dedicated for a specific functionality. In certain embodiments there can be multiple processors.

Processor 110 can be configured to operate with video processor 150 to generate different arrangements of graphical elements in accordance with different criteria. Graphical elements can be different images of people, items, animals, abstract designs, symbols, and the like. Specifically, processor 110 can be configured to implement a security system where upon when a user selects the correct graphical elements, in accordance with a security criteria, the user is granted access to hardware, software, and the like. Processor 110 accesses graphical element database 130 to select from the images contained within graphical elements that match physical characteristics that correspond to a profile which can be stored within memory 120 and/or database 130. Processor 110 also selects graphical elements from database 130 that do not correspond to a profile as well, where the matching and the non-matching graphical elements would be rendered by graphics processor 150 to present a set of graphical elements to a user for selection.

In an illustrative example, the user profile can stipulate that for a first time period, images that are green would represent the correct graphic elements that, if selected, would grant access to secured hardware and software. For a second time period, images of cows would represent the correct graphic elements that, if selected, would grant access to secured hardware and software. Note, time periods can represent months, weeks, days, hours, minutes, seconds, any type of exemplary time period, and the like.

Processor 110 also matches graphical elements that are required to be positioned in a correct spatial arrangement according to a spatial characteristic in accordance with the profile. Examples of spatial characteristics can be that the graphical elements which have the correct physical characteristics are located in certain positions in the presented set of graphical elements. Examples of different type of spatial attributes can include a position on a screen, a position relative to a graphical element, a cardinal direction, a position in a grid, a coordinate system, and global positioning coordinates.

In an illustrative example, a profile can specify for a certain day that all images of cows comply with a correct physical attribute according to security criteria. The profile could also designate that all images of cows that are located in the corners of a presented set of graphical elements would match the correct spatial attribute. For a second day, the correct physical attributes, according to the profile, could be all the presented images objects that are square shaped that are colored red and green. The spatial attributes for the correct graphical elements for the second day would be that the graphical elements matching the correct physical attributes would need to be next to a graphical element that is shaped as a circle. Note, a profile can be pre-designated by a user to comport with graphical elements and positions of such graphical elements that the person finds easy to remember.

Other examples of physical and spatial attributes can be used in accordance with the illustrative principles. TABLE 1 presents an illustrative example of a profile of different security criteria that designate different time periods when varying physical and spatial attributes would be correct for that time period.

TABLE 1

| Time Period | Physical Characteristics | Spatial Characteristics |
|---|---|---|
| First | Graphic elements of cars | Graphic elements that are |
| | that are red and white. | only in the top row of a |
| | | displayed set of graphic |
| | | elements. |
| Second | Graphic elements of any | Graphic elements that are |
| | person that are colored | only in the left most col- |
| | gray. | umn of a displayed set of |
| | | graphical elements. |
| Third | Graphic elements that are | Graphic elements that are |
| | square shaped and that | next to graphic elements |
| | are colored green and | that are circular. |
| | red. | |
| Fourth | Graphic images that have | Graphic elements that are |
| | a wood grain, any color. | in the corners of the ren- |
| | | dered set of graphical ele- |
| | | ments. |
| Fifth | Graphic elements that | Graphic elements that are |
| | contain pictures of | in the second and fourth |
| | animals. | rows of the display set of |
| | | graphical elements. |
| Sixth | Graphic elements that are | Graphic elements that are |
| | shaped as an X with a | adjacent to graphic ele- |
| | hashed texture. | ments that are cars. |

The memory 120 is where the instructions and data to be executed by the processor are stored. The memory 120 can include volatile memory (Read Only Memory), non-volatile memory, or other suitable media. Memory 120 can be configured to operate a database in accordance with the described principles under the direction of processor 110.

Memory 120 can also be configured as a storage device in the form of magnetic media (hard drive), optical media (compact disc/digital video disc), or flash based storage. Memory 120 can also be configured to store information comporting to user account data, transaction data, information comporting to previous media asset transactions by a user, media assets, and the like.

Graphical element database 130 contains the graphic elements that will be used as the elements that a user will select in order to gain access to a secured system. Specifically, graphical element database 130 contains graphic elements such as different images of people, items, animals, abstract designs, symbols, and the like which are capable of being rendered in different colors, textures, patterns, shapes, and the like. For example, the database can be configured to contain pictures of different animals where the same picture of an animal can be rendered, using information from database 130, in different colors, textures, patterns, have the shape of an image modified, and the like. That is, a picture of a cow can be rendered using the database 130 in blue, red, green, purple, brown, black, and the like. Such modifications can be made to other graphical elements that come from graphical database 130 in accordance with the illustrative principles of the present disclosure.

Communication interface 140 handles the communication of server 100 with other devices over a network. Examples of suitable networks include Ethernet networks, Wi-Fi enabled networks, cellular networks, and the like. Other types of suitable networks will be apparent to one skilled in the art given the benefit of this disclosure. Communication interface 140 can also be configured to accept user input which can be data representing the user selection of a number of graphic elements from a presented set of graphic elements. Communication interface 140 can also be configured to accept information from a user input device such as a keyboard, mouse, touch screen, tablet, remote control, computer, wireless device, smart phone, and the like.

Video processor 150 is capable of generating a user interface that displays the selected set of graphic elements in accordance with the illustrative principles. Video processor 150 operates under the control of processor 110 to display the set of selected graphical elements in a designated arrangement, as described herein. Video processor 150 can be configured to display video, generate a video signal that is capable of being displayed, control a display device, and the like.

Security module 160 operates under the control of processor 110 where the module 160 provides access to different applications, operating systems, storage mediums, computer systems, networks, and the like upon the matching of user selected graphic elements, from a presented set of graphic elements, in accordance with the described principles of the present disclosure. Security module 160, for example, controls the internet protocol (IP) packets on a network, where IP packets from a user will be blocked unless a user selects the correct graphical elements from a set of graphical elements as defined in accordance with a profile, as described above.

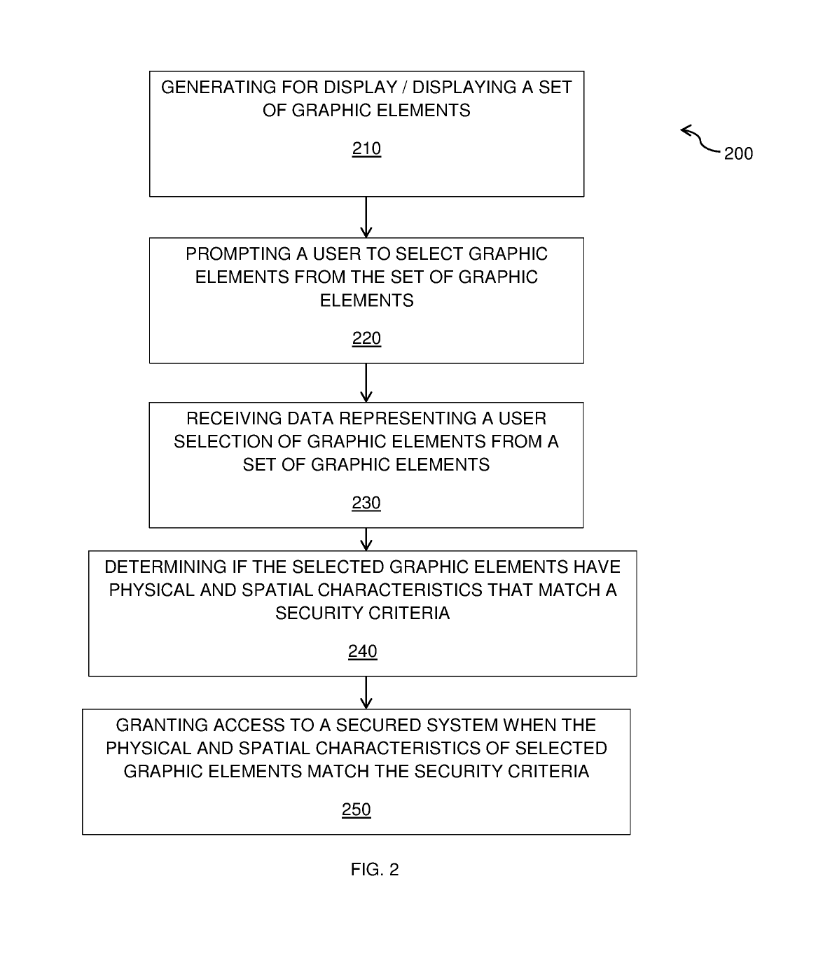

FIG. 2 depicts a flow chart 200 illustrating operations of an exemplary method to grant access to a system in response to correctly selected graphical elements that have attributes that match security criteria. In step 210, a set of graphic elements, as selected by processor 110, is displayed to a user for selection. As described above, several graphical elements are selected from database 130 where the graphic elements comport to at least one common physical attribute designated in a profile. Other graphic elements which don't comport to the common physical attribute are selected by the processor 110 as well, where all of these selected graphic elements are used to form the designated set of graphic elements. In an alternative implementation of step 210, a video processor 150 generates a signal for display that contains a representation of the set of graphic elements.

In step 220, a user can be prompted to select graphic elements from the set of rendered graphic elements. The user can select such graphic elements from the set of graphic elements by use of a user input device. The results of such a selection can be sent to server 100 in the form of data from the user input device. In step 230, user input data that represents the user selection of graphic elements from a set of displayed graphic elements is received by server 110 via communication interface 140, in accordance with an exemplary embodiment.

In step 240, the received user input is processed by processor 110 such that processor 110 determines whether or not the selected graphic elements have physical and spatial characteristics that match security criteria as defined by a profile. As explained earlier, a profile designates specific physical characteristics that selected graphic elements must possess in order to let a user gain access to different components in a secured system. Exemplary attributes for physical attributes for a graphic element can be a color, a texture, a shape, a subject, a pattern, and the like. In some embodiments, such physical attributes are stored in database 130 in the form of metadata that is associated with the images that are used to generate the graphic elements.

The graphical elements that have designated physical characteristics as defined by the profile must also be located in certain positons (spatial characteristics) in the set of displayed graphic elements in order to match the defined security criteria. Exemplary attributes for spatial attributes can include a position on a screen, a position relative to a graphical element, a cardinal direction, a position in a grid, a coordinate system, global positioning coordinates, and the like. Note, the profile can be automatically generated or pre-designated by a user. Also, different physical and spatial characteristics can be used for different time periods in accordance with described exemplary principles.

Access is granted by security module 160, under the control of processor 110, if the user selected graphic elements have physical and spatial characteristics that match the physical and spatial characteristics designated in the security criteria. The access that is granted can include, but is not limited to the operations of: providing access to an application, providing access to an operating system, providing access to a storage medium, providing access to a computer system, providing access to a network, and the like.

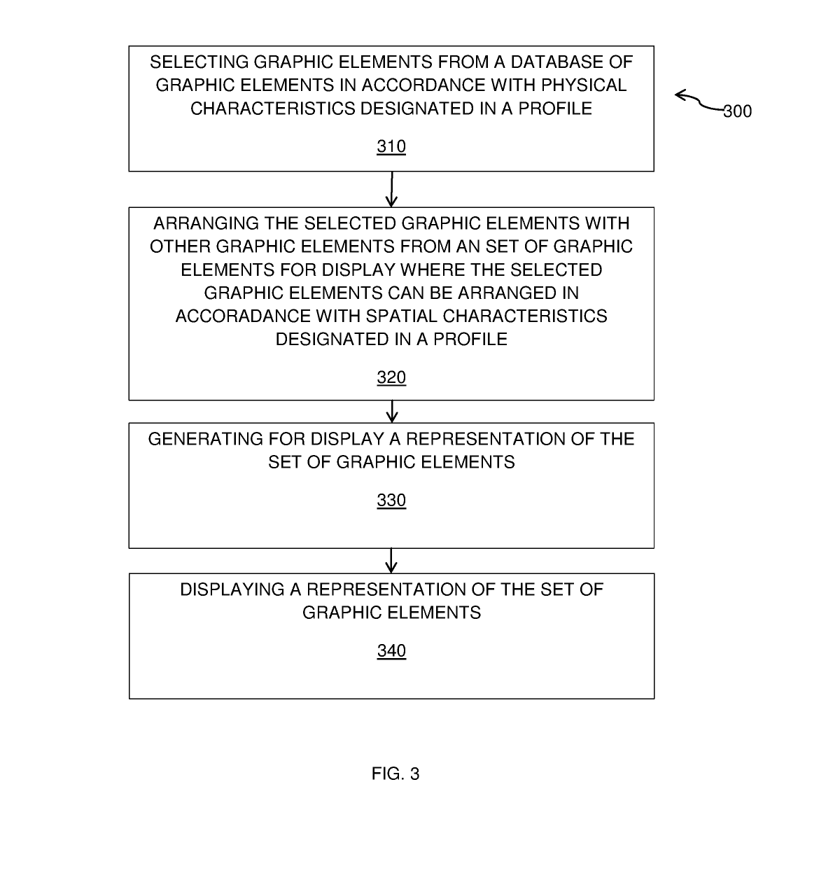

FIG. 3 depicts a flow chart 300 illustrating operations of an exemplary method to generate a set of graphical elements for display containing graphical elements that match security criteria. In step 310, processor 110 selects graphic elements from database 130 that match designated physical characteristics designated in a profile. In some exemplary embodiments, processor 110 selects different images from database 130 that have the color, size, shape, subject, and the like, that are correct for a certain time period.

In step 320, a set of graphic elements is generated by processor 110 where the selected graphic elements are arranged in certain positions with other graphic elements which do not have the designated physical characteristics defined in the profile. The arrangement of the selected graphic elements should be placed in positions that are designated in accordance with the spatial characteristics of the profile. These positons, in accordance with exemplary embodiments, can include a position on a screen, a position relative to a graphical element, a cardinal direction, a position in a grid, a coordinate system, global positioning coordinates, and the like.

Once the set of graphic elements is determined, a representation of the set of graphic elements is generated for, in step 330, for display. Step 330 can be the generation of a signal that is capable of being displayed. An operation of actually displaying the representation of the set of graphic elements can be performed in step 340.

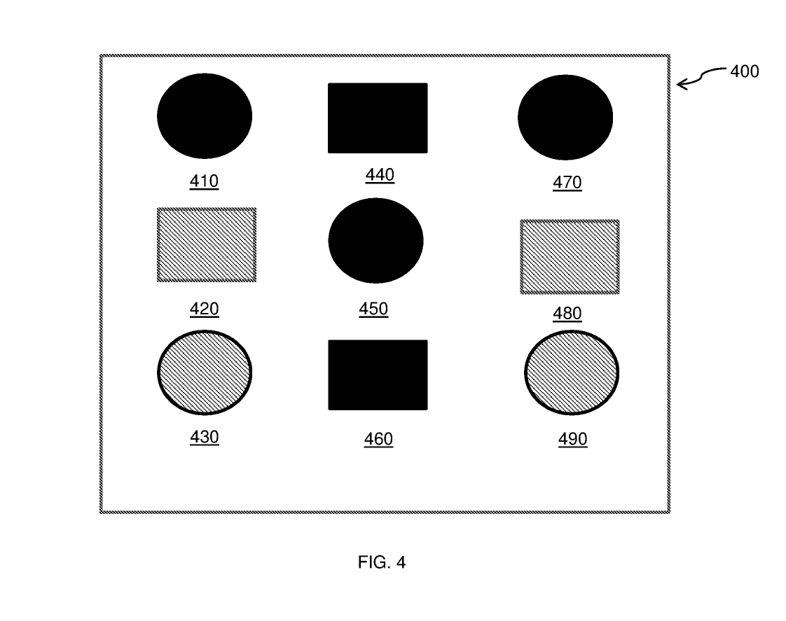

FIG. 4 depicts an exemplary set of graphic elements 400 to be selected by a user in accordance with an illustrative embodiment. Graphic elements 410, 450, and 470 represent images of black circles. Graphic elements 440 and 460 represent images of black squares. Graphic elements 430 and 490 represent circles with a hashed pattern. Graphic elements 420 and 480 represent squares with hashed patterns. The positions of the displayed graphic elements 410-490 are evident from the figure.

In a first illustrative example, a profile can designate that graphic elements that have a physical attribute of being circular would match the security criteria for a current time period. The profile could also designate a spatial attribute that the graphic elements also be located in the corners of the graphic set. Hence, using the specified physical attribute, graphic elements 410, 430, 450, 470, and 490 would match the designated circular criteria. According to the spatial attribute specified in the profile the current time period, graphic elements 410, 430, 470, and 490, if selected by a user, would match the security criteria which would allow access to a secured system. If element 450 is selected by a user, in addition to any one of graphic elements 410, 430, 470, and 490, the system would not allow access to the secured system because element 450 does not have the correct spatial attribute, even though it matches the correct physical attribute.

In a second illustrative example, the physical characteristics defined by the profile for a second time period can specify that the correct graphic elements be black and circular. The spatial characteristic according to the profile is that the graphic element has a hashed square below the correct graphic elements. According to the physical characteristics defined by the profile, graphic elements 410, 450, and 470 are black and circular. When considering the spatial characteristics, as defined by the profile, graphic elements 410 and 470 have hashed squared (420, 480) below which means that graphic elements 410 and 470 would be the graphic elements, if selected, which grant access to a user to access a secured system. Graphic element 450, if selected, would not let user gain access to a secured system because it fails to have the correct spatial characteristics even though it has the correct physical characteristics. Other images of graphic elements, types of physical characteristics, and spatial characteristics can be used in accordance with the exemplary embodiments.

In an optional embodiment of the illustrative concepts, the order in which graphic elements are selected can determine whether or not a user gains access to a secured system. That is, there can be a third aspect to the security criteria that designates a specific order in which graphic elements need to be selected. For example, the order can depend on the position of elements (e.g., from upper right corner to lower left corner), the color of the elements (e.g., black before red), the texture of the elements, alphabetical order for the elements (e.g., selecting a cat before a dog), and the like.

Although embodiments which incorporate the teachings of the present disclosure have been shown and described in detail herein, those skilled in the art can readily devise many other varied embodiments that still incorporate these teachings. Having described preferred embodiments of a system, method and user interface, it is noted that modifications and variations can be made by persons skilled in the art in light of the above teachings. It is therefore to be understood that changes can be made in the particular embodiments of the disclosure disclosed which are within the scope of the disclosure as outlined by the appended claims. In addition, the exemplary embodiments can be embodied in a non-transitory, tangible format in a signal form, as computer code, and the like on a storage medium.

1. A method comprising:
receiving, by at least one hardware processor, data representing a selection of a plurality of graphic elements by a user from a rendered set of graphic elements;
determining, by the at least one hardware processor, if each selected graphic element has at least one physical characteristic and at least one spatial characteristic in the rendered set of graphic elements that match a security criteria; and
granting, by the at least one hardware processor, access to a system when the at least one physical characteristic and the at least one spatial characteristic match the security criteria.

2. The method of claim 1 additionally comprising requesting, by the at least one hardware processor, the selection of a plurality of graphical elements.

3. The method of claim 1 additionally comprising displaying, by the at least one hardware processor, the set of graphic elements on a display device.

4. The method of claim 1 additionally comprising generating, by the at least one hardware processor, a displayable signal containing the set of graphic elements.

5. The method of claim 1, wherein granting access to a system includes at least one of providing access to an application, providing access to an operating system, providing access to a storage medium, providing access to a computer system, and providing access to a network.

6. The method of claim 1, wherein the at least one physical characteristic is selected from the group comprising a color, a texture, a shape, a subject, and a pattern.

7. The method of claim 1, wherein the at least one spatial characteristic is selected from the group comprising a position on a screen, a position relative to a graphical element, a cardinal direction, a position in a grid, a coordinate system, and global positioning coordinates.

8. The method of claim 1, wherein the security criteria is determined accordance with a user profile.

9-10. (canceled)

11. A method comprising:
selecting, by at least one hardware processor, a plurality of graphic elements from a database of graphical elements in accordance with at least one physical characteristic;
arranging, by the at least one hardware processor, the plurality of graphical elements with other graphical elements to form a set of graphical elements for display where the arrangement of the plurality of graphical elements in the set of graphical elements is determined in accordance with at least one spatial characteristic;
generating, by the at least one hardware processor, for display a representation of the set of graphical elements; and
displaying, by the at least one hardware processor, the set of graphic elements on a display device.

12-19. (canceled)

20. An apparatus comprising:
at least one hardware a processor; and
a memory coupled to the at least one hardware processor, the memory for storing instructions which, when executed by the processor, perform the operations of:
receiving data representing a selection of a plurality of graphic elements by a user from a set of graphic elements;
determining if the selected plurality of graphic elements have at least one physical characteristic and at least one spatial characteristic that match a security criteria; and
granting access to a system when the at least one physical characteristic and at least one spatial characteristic match the security criteria.

21. The apparatus of claim 20 further comprising an instruction causing the at least one hardware processor to request the selection of a plurality of graphical elements.

22. The apparatus of claim 20 further comprising an instruction causing the at least one hardware processor to display the set of graphic elements on a display device.

23. The apparatus of claim 20 further comprising an instruction causing the at least one hardware processor to generate a displayable signal containing the set of graphic elements.

24. The apparatus of claim 20, wherein granting access to a system is at least one of providing access to an application, providing access to an operating system, providing access to a storage medium, providing access to a computer system, and providing access to a network.

25. The apparatus of claim 20, wherein the at least one physical characteristic is selected from the group comprising a color, a texture, a shape, a subject, and a pattern.

26. The apparatus of claim 20, wherein the at least one spatial characteristic is selected from the group comprising a position on a screen, a position relative to a graphical element, a cardinal direction, a position in a grid, a coordinate system, and global positioning coordinates.

27. The apparatus of claim 20, wherein the security criteria is determined in accordance with a user profile.

28. The apparatus of claim 27, wherein the user profile is preselected by the user to vary the at least one physical characteristic and the at least one spatial characteristic used for the security criteria after a time period.

29. The apparatus of claim 27, wherein the user profile is determined by a security module such the at least one physical characteristic and the at least one spatial characteristic used for security criteria vary after a time period.

30. An apparatus comprising:
at least one hardware a processor; and
a memory coupled to the at least one hardware processor, the memory for storing instructions which, when executed by the processor, perform the operations of:
selecting a plurality of graphic elements from a database of graphical elements in accordance with at least one physical characteristic;
arranging the plurality of graphical elements with other graphical elements to form a set of graphical elements for display where the arrangement of the plurality of graphical elements in the set of graphical elements is determined in accordance with at least one spatial characteristic;
generating for display a representation of the set of graphical elements; and
displaying the set of graphic elements on a display device.

31-38. (canceled)
